(19) United States
(12) Patent Application Publication
(10) Pub. No.: US 2025/0390781 A1
(43) Pub. Date: Dec. 25, 2025

(54) QUANTUM-ENHANCED METHODS FOR TOPOLOGICAL DATA ANALYSIS

(71) Applicant: IONQ, INC., College Park, MD (US)

(72) Inventor: Jason John IACONIS, Boulder, CO (US)

(21) Appl. No.: 19/248,381

(22) Filed: Jun. 24, 2025

Related U.S. Application Data
(60) Provisional application No. 63/664,070, filed on Jun. 25, 2024.

(51) Int. Cl. G06N 10/60

(52) U.S. Cl. CPC G06N 10/60

(57) ABSTRACT

A method of a noisy intermediate-scale quantum device (NISQ) topological data analysis in a hybrid quantum-classical computing system comprising a classical computer and a quantum processor includes gathering, by the classical computer, dataset, creating, by the classical computer, a simplicial complex of an order k from the dataset, based on a cutoff distance, estimating, by the quantum processor, topological properties of the simplicial complex, the estimating including creating a Hamming weight k state on the quantum processor, projecting the Hamming weight k state onto k-simplices of a graph G, and applying a boundary operator to the quantum processor, creating, by the classical computer, feature vectors from the topological properties of the simplicial complex estimated by the quantum processor, and calculating, by the classical computer, properties of the dataset.

### CROSS-REFERENCE TO RELATED APPLICATIONS

This application claims the benefit of U.S. Provisional Application Ser. No. 63/664,070 filed Jun. 25, 2024, which is herein incorporated by reference in its entirety.

### BACKGROUND

### Field

The present disclosure generally relates to a method of performing computation in a hybrid quantum-classical computing system, and more specifically, to a method of topological data analysis in a hybrid computing system that includes a classical computer and a quantum computer that includes trapped ions.

### Description of the Related Art

In current state-of-the-art quantum computers, control of qubits is imperfect (noisy) and the number of qubits used in these quantum computers generally range from a hundred qubits to thousands of qubits. The number of quantum gates that can be used in such a quantum computer (referred to as a “noisy intermediate-scale quantum device” or “NISQ device”) to construct circuits to run an algorithm within a controlled error rate is limited due to the noise.

One of the problems that can be solved efficiently in a hybrid quantum-classical computing system is to characterize the large-scale high-dimensional structures present in real world data by measuring the topological properties of a given datasets. This topological information can then be integrated with various classical algorithms, including classical machine learning (ML) methods in order to better predict properties of the data samples.

By using tools from the field of algebraic topology, topological data analysis (TDA) is used to extract meaningful information concerning the shape and large scale structure present in a collection of data points, which can be useful for understanding and predicting behavior. TDA is a rapidly growing field of study in data sciences with applications to a diverse set of problems where the underlying behavior can be better predicted by understanding the complex relationships between collections of many data points.

The methods of TDA can be applied to many different types of data across various application areas. Some of these applications include analyzing gene expression data to improve the likelihood of predicting cancer diagnoses, understanding the genetic evolutionary relationships between different organisms, studying the structure and predicting the behavior of different proteins and understanding the structure of neural network machine learning models.

### SUMMARY

Embodiments of the present disclosure provide a method of a noisy intermediate-scale quantum device (NISQ) topological data analysis in a hybrid quantum-classical computing system comprising a classical computer and a quantum processor. The method includes gathering, by the classical computer, dataset, creating, by the classical computer, a simplicial complex of an order k from the dataset, based on a cutoff distance, estimating, by the quantum processor, topological properties of the simplicial complex, the estimating including creating a Hamming weight k state on the quantum processor, projecting the Hamming weight k state onto k-simplices of a graph G, and applying a boundary operator to the quantum processor, creating, by the classical computer, feature vectors from the topological properties of the simplicial complex estimated by the quantum processor, and calculating, by the classical computer, properties of the dataset.

Embodiments of the present disclosure also provide a hybrid quantum-classical computing system. The hybrid quantum-classical computing system includes a classical computer configured to: gather dataset, and create a simplicial complex of an order k from the dataset, based on a cutoff distance, and a quantum processor comprising a plurality of trapped ions, each of the trapped ions having two hyperfine states defining a qubit, wherein the quantum processor configured to: estimate topological properties of the simplicial complex by: creating a Hamming weight k state, projecting the Hamming weight k state onto k-simplices of a graph G, and applying a boundary operator, wherein the classical computer is further configured to: create feature vectors from the topological properties of the simplicial complex estimated by the quantum processor, and calculate properties of the dataset.

Embodiments of the present disclosure further provide a quantum computing system for performing an auxiliary field quantum Monte Carlo simulation of a many-electron system, the quantum computing system comprising non-volatile memory having a number of instructions stored therein. The number of instructions, when executed by one or more processors, causes the quantum computing system to perform operations including gathering, by a classical computer, dataset, creating, by the classical computer, a simplicial complex of an order k from the dataset, based on a cutoff distance, estimating, by a quantum processor, topological properties of the simplicial complex, the estimating including creating a Hamming weight k state on the quantum processor, projecting the Hamming weight k state onto k-simplices of a graph G, and applying a boundary operator to the quantum processor, creating, by the classical computer, feature vectors from the topological properties of the simplicial complex estimated by the quantum processor, and calculating, by the classical computer, properties of the dataset.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic partial view of an ion trap quantum computing system according to one embodiment.

FIG. 2A depicts a schematic energy diagram of each ion in an ion chain according to one embodiment.

FIG. 2B depicts a schematic motional sideband spectrum of an ion in an ion chain according to one embodiment.

FIG. 3 shows examples of k-simplices.

FIG. 4 shows the difference between a VR complex and a Cech complex.

FIG. 5 shows a filtration showing a VR complex of a set of nodes at different length-scales ϵ.

FIG. 6 depicts a process flow diagram of a noisy intermediate-scale quantum device (NISQ) topological data analysis (TDA) method for analyzing brain function data with applications in distinguishing between healthy and abnormal brain functions, according to one or more embodiments of the present disclosure.

FIG. 7 shows a circuit to create a Hamming weight k state (k=3) on N=6 qubits.

FIG. 8A shows a circuit of a projection operator Pₖ (k=3) on N=7 vertex qubits for a graph G. FIG. 8B shows an example graph G.

FIG. 9 shows a circuit to implement a free-fermion Hamiltonian B.

FIG. 10 shows a workflow of a noisy intermediate-scale quantum device (NISQ) topological data analysis (TDA) method according to one or more embodiments of the present disclosure.

To facilitate understanding, identical reference numerals have been used, where possible, to designate identical elements that are common to the figures. It is contemplated that elements disclosed in some embodiments may be beneficially utilized on other implementations without specific recitation.

### DETAILED DESCRIPTION

Embodiments described herein are generally related to a method and a system for performing a computation using a hybrid quantum-classical computing system, and, more specifically, to topological data analysis using a hybrid quantum-classical computing system that includes an ion chain including trapped ions.

The embodiments described herein provide a full workflow for applying quantum topological Betti number estimation to aid in predicting properties of real world problems, with a particular focus on analyzing brain function data with applications in distinguishing between healthy and abnormal brain functions. In this framework, the input data is gathered and stored as a collection of points. The pairwise distances between these points are used to form a graph which defines the simplicial complex. This simplicial complex is then used as input to the quantum algorithm. A series of quantum circuits which depend on the input simplicial complex are executed and the measurement outcomes of these quantum circuits are stored. These output measurements are then post-processed using a classical computer to generate a classical feature vector. This feature vector may be an estimate of the k-th Betti number for a specific length scale. This process can be repeated multiple times to derive a Betti curve of the topological data as a function of length scale. The processed topological information is then used as input to a classical algorithm which predicts properties of the sample.

As an example of how this works, the specific case of predicting Alzheimer's disease from functional MRI data is described. In this case, a functional MRI (fMRI) scan of the brain is the input data. From this data, a series of brain hubs are identified and used as nodes of the graph, and the distance ϵ, between nodes is defined as the amount of neural activity between those two nodes. In this way, at a specified cutoff activity level ϵ, defines a simplicial complex. This complex is the input to the quantum algorithm. Using this input, a series of quantum circuits are applied, and the measurement outcomes are stored. These measurements are processed to estimate the k-th Betti number. This is repeated for different values of distance ϵ and different values of k. The Betti curves that are calculated can then be directly used to predict the age of the brain sample or to diagnose the presence of Alzheimer's disease.

### General Hardware Configurations

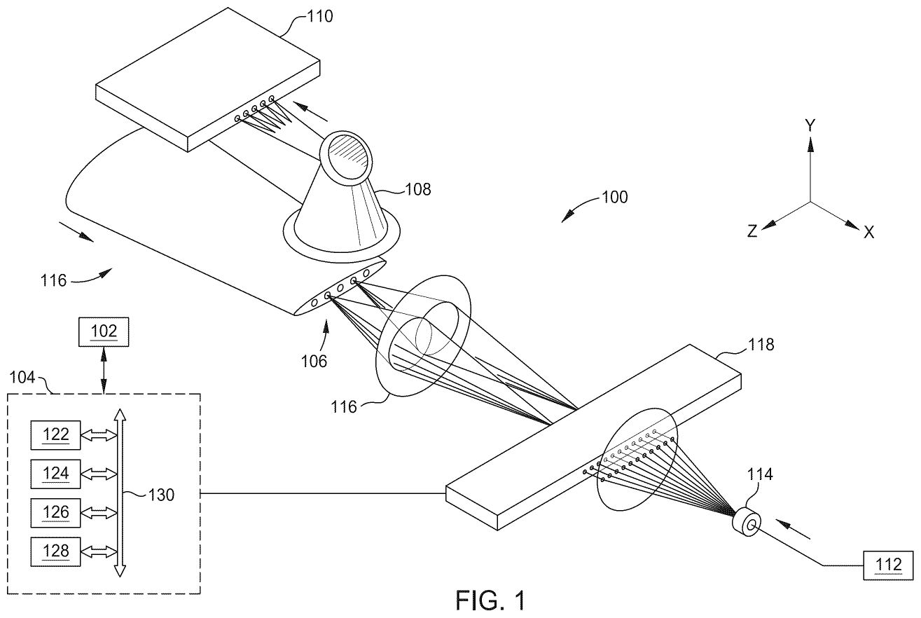

FIG. 1 is a schematic partial view of an ion trap quantum computing system, or system 100, according to one embodiment. The system 100 includes a classical (digital) computer 102, a system controller 104 and a quantum processor that is an ion chain 106 having trapped ions (i.e., five shown) that extend along the Z-axis. The classical computer 102 includes a central processing unit (CPU), memory, and support circuits (or I/O). The memory is connected to the CPU, and may be one or more readily available memories, such as a read-only memory (ROM), a random-access memory (RAM), floppy disk, hard disk, or any other form of digital storage, local or remote. Software instructions, algorithms and data can be coded and stored within the non-volatile memory for instructing the CPU. The support circuits (not shown) are also connected to the CPU for supporting the processor in a conventional manner. The support circuits may include conventional cache, power supplies, clock circuits, input/output circuitry, subsystems, and the like.

An imaging objective 108, such as an objective lens with a numerical aperture (NA), for example, of 0.37, collects fluorescence along the Y-axis from the ions and maps each ion onto a multi-channel photo-multiplier tube (PMT) 110 for measurement of individual ions. Non-copropagating Raman laser beams from a laser 112, which are provided along the X-axis, perform operations on the ions. A diffractive beam splitter 114 creates an array of static Raman beams 116 that are individually switched using a multi-channel acousto-optic modulator (AOM) 118 and is configured to selectively act on individual ions. A global Raman laser beam 120 illuminates all ions at once. The system controller (also referred to as a “RF controller”) 104 controls the AOM 118 and thus controls laser pulses to be applied to trapped ions in the ion chain 106. The system controller 104 includes a central processing unit (CPU) 122, a read-only memory (ROM) 124, a random-access memory (RAM) 126, a storage unit 128, and the like. The CPU 122 is a processor of the system controller 104. The ROM 124 stores various programs and the RAM 126 is the working memory for various programs and data. The storage unit 128 includes a nonvolatile memory, such as a hard disk drive (HDD) or a flash memory, and stores various programs even if power is turned off. The CPU 122, the ROM 124, the RAM 126, and the storage unit 128 are interconnected via a bus 130. The system controller 104 executes a control program which is stored in the ROM 124 or the storage unit 128 and uses the RAM 126 as a working area. The control program will include software applications that include program code that may be executed by processor in order to perform various functionalities associated with receiving and analyzing data and controlling any and all aspects of the methods and hardware used to create the ion trap quantum computer system 100 discussed herein.

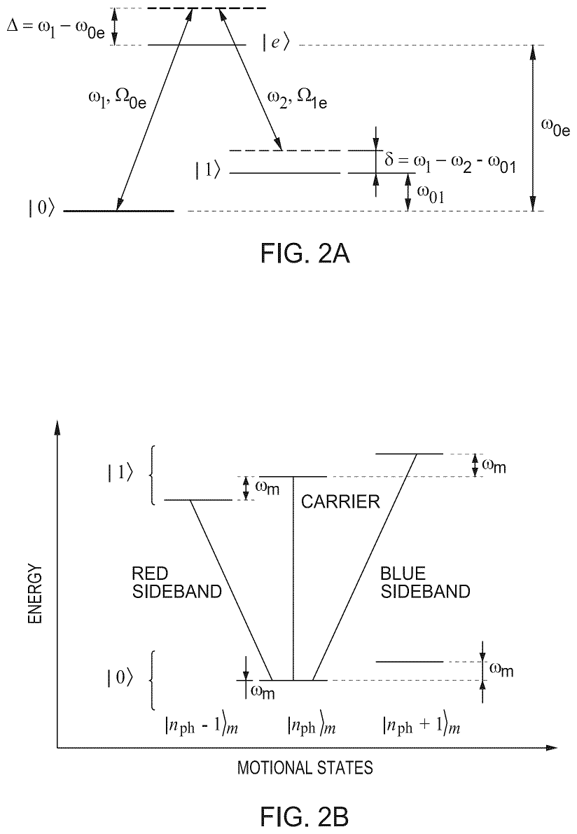

FIG. 2A depicts a schematic energy diagram of each ion in the ion chain 106 according to one embodiment. In one example, each ion may be a positive Ytterbium ion, ¹⁷¹Yb⁺, which has the ²S_{1/2} hyperfine states (i.e., two electronic states) with an energy split corresponding to a frequency difference (referred to as a “carrier frequency”) of ω₀₁/2π=12.6 GHz. A qubit is formed with the two hyperfine states, used to represent computational basis |0 [symbol] and |1 [symbol] (|i [symbol] (i∈Z)), where the hyperfine ground state (i.e., the lower energy state of the ²S_{1/2} hyperfine states) is chosen to represent |0 [symbol] . Hereinafter, the terms “hyperfine states,” “internal hyperfine states,” and “qubit states” may be interchangeably used to represent computational basis states |0 [symbol] and |1 [symbol] (|i [symbol] (i∈Z)). Each ion may be cooled (i.e., kinetic energy of the ion may be reduced) to near the motional ground state |0 [symbol] ₘ for any motional mode m with no phonon excitation (i.e., nₚₕ=0) by known laser cooling methods, such as Doppler cooling or resolved sideband cooling, and then the qubit state prepared in the hyperfine ground state |0 [symbol] by optical pumping. Here, |0 [symbol] represents the individual qubit state of a trapped ion whereas |0 [symbol] ₘ with the subscript m denotes the motional ground state for a motional mode m of the ion chain 106.

An individual qubit state of each trapped ion may be manipulated by, for example, a mode-locked laser at 355 nanometers (nm) via the excited ²P_{1/2} level (denoted as |e [symbol] ). As shown in FIG. 2A, a laser beam from the laser may be split into a pair of non-copropagating laser beams (a first laser beam with frequency ω₁ and a second laser beam with frequency ω₂) in the Raman configuration, and detuned by a one-photon transition detuning frequency Δ=ω₁−ω₀ₑ with respect to the transition frequency ω₀ₑ between |0) and |e), as illustrated in FIG. 2A. A two-photon transition detuning frequency δ includes adjusting the amount of energy that is provided to the trapped ion by the first and second laser beams, which when combined is used to cause the trapped ion to transfer between the hyperfine states |0 [symbol] and |1 [symbol] . When the one-photon transition detuning frequency Δ is much larger than a two-photon transition detuning frequency (also referred to simply as “detuning frequency”) δ=Ω₁−ω₂−ω₀₁ (hereinafter denoted as ±μ, μ being a positive value), single-photon Rabi frequencies Ω₀ₑ(t) and Ω₁ₑ(t) (which are time-dependent, and are determined by amplitudes and phases of the first and second laser beams), at which Rabi flopping between states |0 [symbol] and |e [symbol] and between states |1 [symbol] and |e [symbol] respectively occur, and a spontaneous emission rate from the excited state |e [symbol] , Rabi flopping between the two hyperfine states |0 [symbol] and |1 [symbol] (referred to as a “carrier transition”) is induced at the two-photon Rabi frequency Ω(t). The two-photon Rabi frequency Ω(t) has an intensity (i.e., absolute value of amplitude) that is proportional to Ω₀ₑΩ₁ₑ/2Δ, where Ω₀ₑ and Ω₁ₑ are the single-photon Rabi frequencies due to the first and second laser beams, respectively. Hereinafter, this set of non-copropagating laser beams in the Raman configuration to manipulate internal hyperfine states of qubits (qubit states) may be referred to as a “composite pulse” or simply as a “pulse,” and the resulting time-dependent pattern of the two-photon Rabi frequency Ω(t) may be referred to as an “amplitude” of a pulse or simply as a “pulse,” which are illustrated and further described below. The detuning frequency δ=ω₁−ω₂−ω₀₁ may be referred to as detuning frequency of the composite pulse or detuning frequency of the pulse. The amplitude of the two-photon Rabi frequency Ω(t), which is determined by amplitudes of the first and second laser beams, may be referred to as an “amplitude” of the composite pulse.

It should be noted that the particular atomic species used in the discussion provided herein is just one example of atomic species which has stable and well-defined two-level energy structures when ionized and an excited state that is optically accessible, and thus is not intended to limit the possible configurations, specifications, or the like of an ion trap quantum computer according to the present disclosure. For example, other ion species include alkaline earth metal ions (Be⁺, Ca⁺, Sr⁺, Mg+, and Ba⁺) or transition metal ions (Zn⁺, Hg⁺, Cd⁺).

FIG. 2B depicts a schematic motional sideband spectrum of each ion in the ion chain 106 in a motional mode |nₚₕ [symbol] _{M} having frequency ωₘ according to one embodiment. As illustrated in FIG. 2B, when the detuning frequency of the composite pulse is zero (i.e., a frequency difference between the first and second laser beams is tuned to the carrier frequency, δ=ω₁−ω₂−ω₀₁=0), simple Rabi flopping between the qubit states |0 [symbol] and |1 [symbol] (carrier transition) occurs. When the detuning frequency of the composite pulse is positive (i.e., the frequency difference between the first and second laser beams is tuned higher than the carrier frequency, δ=ω₁−ω₂−ω₀₁=μ>0, referred to as a blue sideband), Rabi flopping between combined qubit-motional states |0 [symbol] |nₚₕ [symbol] ₘ and |1 [symbol] |nₚₕ+1 [symbol] ₘ occurs (i.e., a transition from the m-th motional mode with n-phonon excitations denoted by |nₚₕ [symbol] ₘ to the m-th motional mode with (nₚₕ+1)-phonon excitations denoted by |nₚₕ+1 [symbol] ₘ occurs when the qubit state |0 [symbol] flips to |1 [symbol] ). When the detuning frequency of the composite pulse is negative (i.e., the frequency difference between the first and second laser beams is tuned lower than the carrier frequency by the frequency ωₘ of the motional mode |nₚₕ [symbol] ₘ, δ=ω₁−ω₂−ω₀₁=−μ<0, referred to as a red sideband), Rabi flopping between combined qubit-motional states |0 [symbol] |nₚₕ [symbol] ₘ and |1 [symbol] |nₚₕ−1 [symbol] ₘ occurs (i.e., a transition from the motional mode |nₚₕ [symbol] ₘ to the motional mode |nₚₕ−1 [symbol] ₘ with one less phonon excitations occurs when the qubit state |0 [symbol] flips to |1 [symbol] ). A π/2-pulse on the blue sideband applied to a qubit transforms the combined qubit-motional state |0 [symbol] |nₚₕ [symbol] ₘ into a superposition of |0 [symbol] |nₚₕ [symbol] ₘ and |1 [symbol] |nₚₕ+1 [symbol] ₘ. A π/2-pulse on the red sideband applied to a qubit transforms the combined qubit-motional |0 [symbol] |nₚₕ [symbol] ₘ into a superposition of |0 [symbol] |nₚₕ [symbol] ₘ and |1 [symbol] |nₚₕ−1 [symbol] ₘ. When the two-photon Rabi frequency Ω(t) is smaller as compared to the detuning frequency δ=ω₁−ω₂−ω₀₁=±μ, the blue sideband transition or the red sideband transition may be selectively driven. Thus, qubit states of a qubit can be entangled with a desired motional mode by applying the right type of pulse, such as a π/2-pulse, which can be subsequently entangled with another qubit, leading to an entanglement between the two qubits that is needed to perform an XX-gate operation in an ion trap quantum computer.

### Quantum-Enhanced Methods for Topological Data Analysis

As the popularity of data-based science has accelerated rapidly over the past decade, the desire for more advanced analysis techniques has similarly increased dramatically. While machine learning and AI models have shown tremendous success in learning from data for a certain class of problems, there still exist many domains where the current techniques struggle. In recent years, the community has begun to appreciate that higher order interactions beyond simple pairwise relationships may be critical for understanding the behavior of systems which can be represented by complex networks.

Topological data analysis (TDA) is a tool which can be used to understand such higher order relationships in real world data. At its core, TDA is a tool for measuring the degree of similarity between different networks, by measuring the shape of the data. By using tools from algebraic topology, features which characterize the global structure of the data can be extracted and then be used in downstream AI models to better predict or classify the behavior of the underlying object. However, extracting these topological features becomes computationally difficult when one wants to look at the higher order features in the dataset.

There exist classical algorithms for calculating the topological properties of data sets. These algorithms calculate the so-called “Betti numbers.” However, they are fundamentally limited, at least in the hardest cases. At its core, this limitation stems from the fact that in order to characterize the k-th dimensional topological characteristics of a dataset, the full set of relationships between any subset of k data points must be considered. The number of different k-body relationships in a set of data points grows as n^{k}, and most classical algorithms need to analyze a matrix of this size. Therefore, up until now TDA techniques have mainly been applied to study the low-dimensional topological properties of data. Extracting the high-dimensional topological properties of complex data sets is generally too computationally costly to calculate on a classical computer.

Quantum algorithms have been proposed for studying topological data analysis, which in the best case can give an exponential speedup over the standard classical approaches known in the art. As in the classical algorithms, these quantum algorithms extract the kth Betti numbers from a simplicial complex. The initial algorithms for extracting the Betti numbers were designed for fault-tolerant quantum computers which require circuit depths beyond what are possible in the near future. There have been proposed algorithms to reduce the depths needed for these computations, however these proposals still require relatively high depth circuits to guarantee the output results.

The embodiments described herein provide the integration of a near-term version of a quantum algorithm which is capable of extracting the high-dimensional topological properties of the data, with a classical TDA workflow which is able to predict the properties of input data, for example to predict properties of the human brain from brain activity data (e.g., structural and functional MRI (fMRI) scans) to identify abnormal brain activity associated with Alzheimer's disease and delirium. This high-dimensional topological information will allow for an unprecedented level of analysis on certain data samples. A quantum-enhanced algorithm described herein is specifically designed to integrate with classical machine learning workflows in order to include a calculation of the topological characteristics of the data (“the Betti curves”) as an input feature to be used for predicting properties of the data samples. The integration of the quantum TDA algorithm in an end-to-end application is described, which can be applied to analyze brain function, and which can be adapted to be applied to other applications.

### 2. Background and Theory

Topological data analysis (TDA) provides a mathematical tool to study higher order networks, where interactions beyond simple pairwise or dyadic relationships are explicitly included in the model.

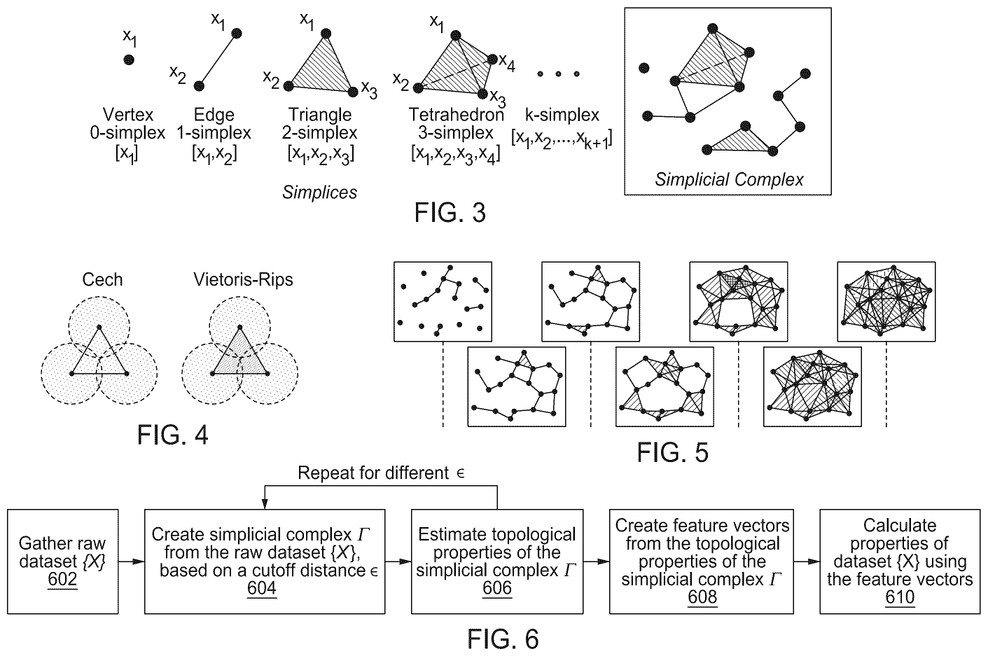

A k-simplex, as shown in FIG. 3, is a set of nodes, edges, and generally k-simplices, for k∈ [symbol] (i.e., a k-dimensional polytope that is the convex hull of k vertices). In other words, a k-simplex is a generalization of a triangle or tetrahedra to k dimensions. In a graph G, the vertices and edges of a k-simplex form a k-clique, that is a fully connected sub-graph on those k vertices.

A simplicial complex Γ, also shown in FIG. 3, may be thought of as a generalization of a graph G and explicitly includes geometric structures beyond nodes and edges (0-simplexes and 1-simplexes respectively), such as triangles (2-simplexes), tetrahedra (3-simplexes), and generally k-simplexes.

In a general network with N vertices, the number of possible k-simplexes for any order k is given by

$$( \begin{matrix}N \\ k\end{matrix} ) ,$$

and the number of total possible simplexes over all orders k is

$${\sum }_{k} ( \begin{matrix}N \\ k\end{matrix} ) = {2}^{N} .$$

Therefore, even enumerating all the elements of a simplicial complex Γ can be computationally challenging. There are several different methods which can construct a simplicial complex Γ from a given set of points (nodes) in a space with an associated measure of distance between the nodes (i.e. a metric space).

Vietoris Rips (VR) complex/Clique Complex: By far the most common structure among simplicial complexes is known as the Vietoris Rips (VR) complex. In this construction, a k-simplex is added to the complex if all pairwise distances between the set of k points are less than a specified threshold ϵ. Therefore, an edge is added to the complex if the two endpoints are less than ϵ distance apart, a triangle is added to the complex if all edges of the triangle are less than ϵ distance apart, a tetrahedron is added to the complex if all triangles on its face are less than ϵ distance apart, and so on for higher order k-simplexes. Every VR complex is also a clique complex, where given a simple graph G, a complex is formed by also including every k-simplex that is a clique of the graph G (i.e. a set of k nodes in graph G that are fully connected to each other). VR complexes have the advantage that they are relatively simple to construct since only pairwise distances are needed, although in the worst case the complexity of this method is still [symbol] (2^{N}). There also exist other complexes which can be useful for analyzing the underlying data and have their own advantages and disadvantages. One example is the Cech complex, where a k-simplex is included in the complex if and only if the intersection of all balls of radius ϵ centered around each of the k points is non-empty, as shown in FIG. 4. In the VR complex the 2-simplex (triangle) is included since all its constituent edges are less than ϵ distance apart. The same set of points are not included in the associated Cech complex, since the intersection of the three circles of radius ϵ is empty.

Homology is a tool used to analyze these simplicial complexes Γ. Homology seeks to measure the degree of similarity between different data sets by measuring the properties about the shape of the data set. The topological properties of the simplicial complex Γ are measured by forming data in the metric space. The topology of the complex measures the global characteristics of its shape which remain the same under smooth local changes to the structure. Specifically, the so called Betti number in dimension k is measured, which counts the number of “k-dimensional holes” in the complex.

In fact, the main tool used to generate features that characterize a data set is measurement of homology as a function of length scale. This process gives a measure that combines both the local geometry and the global topology of the data set. To do this, a sequence of simplicial complexes Γ is formed.

A filtration, shown in FIG. 5, is a collection of complexes which are subsets of each other, which is a sequence of simplicial complexes Γ as a function of a distance parameter e, where each subsequent complex is a super-set of an earlier complex. This method is known as persistent homology, as it measures the topological features of the data set which persist across different length scales.

### 3. Applications to Relevant Problems

### 3.1. Brain Function Analysis Using Functional MRI (fMRI) Data

Understanding complicated and changing connections in the human brain has been the focus of the National Institute of Health since 2011, when it launched the Human Connectome Project to study the detection of underlying neurological problems. Recent studies have shown that functional magnetic resonance imaging (fMRI) data can be used to form highly connected graphs that show functional relationships between many spatially separated nodes in the brain, leading to complexes where the existence of higher-dimensional structures may be more prevalent. Recently, there has been a growing body of evidence showing that taking the higher-order structure into account when modeling brain function can greatly enhance modeling capacities and predict their emerging dynamical behaviors. Topological data analysis (TDA) can be used to study higher-order homologies and Betti numbers based on these studies.

In this study a publicly available dataset, called OASIS3, is used, for which access to the NITRC website is required. This repository has ≥1300 patients, with 755 cognitively normal adults and 622 individuals at various stages of cognitive decline (such as Dementia, Alzheimer's) ranging in age from 42 to 95 years. The dataset contains 2842 MRI sessions, including both structural and functional MRI data. It also contains clinical data sets consisting of questionnaire sessions every time a patient visits. It should be noted that each scan data file is ˜75 MB.

The dataset from the study is pre-processed to feed into the NISQ TDA algorithm. Each fMRI scan file is a 4-dimensional dataset, that is, there is a time series for each 3D voxel of the brain corresponding to its varying signal intensity over time. This in general is large. Apart from the standard preprocessing steps where slice and motion correction are implemented, a key step is to identify the regions of interest (ROI) or major cluster nodes in the brain. Compared to brute-force clustering, ROI extraction helps in retaining richer information about the functional connectivity between different regions while compressing the total size of the connectivity graph to within ˜50-100 nodes.

In the dataset pro-processing, two methodologies are employed: In the first method, the time series data from each ROI is converted directly to point clouds using the embedding technique. In the second method, correlations between different time series of ROIs are used to construct adjacency matrices and graphs. In the first method, for example, time series from 48 ROIs are extracted and then converted to 10-dimensional point clouds with ˜150. Next, using Vietoris-Rips filtration, persistent homology information on these point clouds (persistence diagrams (PD)) for homological dimensions 0, 1, 2, 3 and 4 are extracted. This gives birth and death information of all features in each dimension across different values of the filtration parameter.

Once the persistence diagrams (PD) from each ROI is extracted, distance between them for every pair of ROIs is calculated and a correlation matrix C for each homological dimension is constructed. This matrix has rich information about the functional connectivity between different regions of the brain. On implementing this protocol on the fMRI data from two patients, one cognitively healthy and one diagnosed with Alzheimer's, the functional connectivity of the two brains can be differentiated.

$$C = ( \begin{matrix}D ( PD ( {ROI}_{1} , {ROI}_{1} ) ) & D ( PD ( {ROI}_{1} , {ROI}_{2} ) ) & … & D ( PD ( {ROI}_{1} , {ROI}_{n} ) ) \\ D ( PD ( {ROI}_{2} , {ROI}_{1} ) ) & D ( PD ( {ROI}_{2} , {ROI}_{2} ) ) & … & D ( PD ( {ROI}_{2} , {ROI}_{n} ) ) \\ ⋮ & ⋮ & ⋮ & ⋮ \\ D ( PD ( {ROI}_{n} , {ROI}_{1} ) ) & D ( PD ( {ROI}_{n} , {ROI}_{2} ) ) & … & D ( PD ( {ROI}_{n} , {ROI}_{n} ) )\end{matrix} ) \qquad ( 1 )$$

### Using fMRI-TDA Features for Disease Identification

These distinct features in the correlation matrices C (1) in higher homological dimensions can be further fed into a classifier to identify Alzheimer's or other cognitive/neurological issues among patients. In that case, the classifier is trained on multiple correlation matrices from a training dataset consisting of both cognitively healthy and sick patients. This dataset is available in the OASIS repository. A systematic study of the robustness of these features at higher homological dimensions, such as 5, 6, or more, or dense clique regimes, would be particularly relevant for NISQ-TDA. Along with going to higher homologies, experiments with larger point clouds (that is, more ROIs) would be important in this case.

Extraction of these additional features at higher homologies also begs the question of how they contribute towards better classification, whether in terms of accuracy, convergence time of training the classifier or even fewer training samples. In addition to identifying the utility of these additional TDA features, verification is needed to see if they have different effects in the two types of signals (BOLD and PASL), and if disease detection can be improved by combining the two.

The correlations between different time series of ROIs can be used to extract Betti numbers using the GUDHI library, an open-source library for Computational Topology and Topological Data Analysis (TDA). The input to the GUDHI library can be a list of connected nodes of a graph G or the adjacency matrix A. The output of the GUDHI library can be a simplicial complex Γ. As a result, the correlation matrices C must be converted to an adjacency matrix A, and the list of connected nodes can be extracted based on a particular threshold. Note that for a correlation matrix C, the adjacency matrix A is given by A=1−C. For a particular threshold thr, the list of edges includes all pairs [i, j] such that A_{i,j}≤thr and j>i.

### 3.2. TDA for Finance

Financial institutions often process a large amount of data in many ways for a variety of purposes forecasting market behavior and optimizing portfolios. The set of tools used for these calculations spans the range from heuristic indicators to stochastic simulations and complex machine learning models. However, there are major challenges when working with the types of noisy time series data often associated with financial markets. For one, the market is a highly complex system with complicated high order interactions between different assets affecting the overall behavior. Secondly, the data available for some tasks may be very noisy, sparse, and difficult to obtain. For this reason, it is often difficult to predict so called “black swan events”, such as extreme market swings.

To this end, applying techniques from topological data analysis to financial data may efficiently extract features related to the relationships between different assets over different time periods. It has been seen that TDA can be very effective at predicting extreme market events, such as sudden crashes.

In order to analyze time series data using methods from TDA, the time series must be converted to a point cloud. The typical method for analyzing time series data as a point cloud is to use a time delay embedding, where points in a D-dimensional space are constructed from a single time series by sampling the time series at D different times, each separated by a constant delay t. That is, a series of points is constructed:

$${y}_{t} = ( y ( t ) , y ( t + τ ) , y ( t + 2 τ ) , … , y ( t + D τ ) ) . \qquad ( 2 )$$

A point cloud can then be constructed from the original data by generating multiple points at different locations t along the time series. Takens embedding theorem states that, as long as the dimension D is sufficiently large, the resulting point cloud reconstructs the manifold of the attractor of the original dynamics. That is, the dynamics of the time series may generally depend on a large number of variables n and the time evolution of the system forms a geometric structure in the n dimensional phase space. However, only some of these variables are accessible, for example the stock price as a function of time. Takens theorem states that the shape of the full structure in the original n-dimensional phase space can be reconstructed just from time-delayed sampled from the single variable, as long as enough points D are sampled. Therefore, the shape of the time-delay embedded point cloud contains important information about the relationship between hidden parameters of dynamics.

This method can also be extended to cases with multi-dimensional time series data, in several ways. For example, the dimension of the points in the point cloud can be extended for M correlated time series, to generate a point cloud in MD dimensional space, by applying a time delay embedding which samples M dimensional data at D separate times. Alternately, one may generate a separate point cloud for each of the M marginal time series functions, to get M separate points clouds, each with N points in D dimensional space. One can then concatenate these point clouds together to form one larger point cloud with NM points in D dimensional space.

### 4. Noisy Intermediate-Scale Quantum Device (NISQ) TDA Algorithm

FIG. 6 depicts a process flow diagram of a noisy intermediate-scale quantum device (NISQ) topological data analysis (TDA) method 600 for analyzing brain function data with applications in distinguishing between healthy and abnormal brain functions, according to one or more embodiments of the present disclosure.

The method 600 is performed by a noisy intermediate-scale quantum device (NISQ) device, such as the hybrid quantum-classical computing system 100, which includes a trapped-ion based quantum processor (QPU), such as the ion chain 106, a classical computer, such as the classical computer 102, and a system controller, such as the system controller 104.

The method 600 begins with block 602, in which raw dataset {X} is gathered, by the classical computer. The raw dataset {X} may be an adjacency matrix A that can be calculated from the correlation matrix C in (1) extracted from fMRI scan data of a brain.

In block 604, a simplicial complex Γ of an order k (k∈ [symbol] ) is created from the raw dataset {X}, based on a cutoff distance ϵ, by the classical computer. The simplicial complex Γ may be the output of the GUDHI library when the raw dataset {X} is input.

In block 606, topological properties of the simplicial complex Γ (such as Betti numbers) are estimated using the quantum processor.

Step 1: Create a Hamming weight k state, which is a superposition state over all k simplices (k∈ [symbol] ).

For example, the Hamming weight k (k=2 and 3) state on N=6 vertex qubits (q₀, q₁, q₂, q₃, q₄, q₅, q₆) is:

$$\vert k = 2 〉 = \vert 110000 〉 + \vert 101000 〉 + \vert 100100 〉 + \vert 100010 〉 + \vert 100001 〉 + \vert 011000 〉 + \vert 010100 〉 + …$$

$$\vert k = 3 〉 = \vert 111000 〉 + \vert 110100 〉 + \vert 110010 〉 + \vert 110010 〉 + \vert 110001 〉 + \vert 011100 〉 + \vert 011010 〉 + …$$

To prepare a Hamming weight k state, a probabilistic state preparation step is performed, by generating a weighted superposition over all basis states through single qubit rotations U, and counting the number of “1”s in each basis state through a quantum phase estimation (QPE) operator with the Hamiltonian:

$$H = {\sum }_{i} ( {Z}_{i} + nI ) / 2.$$

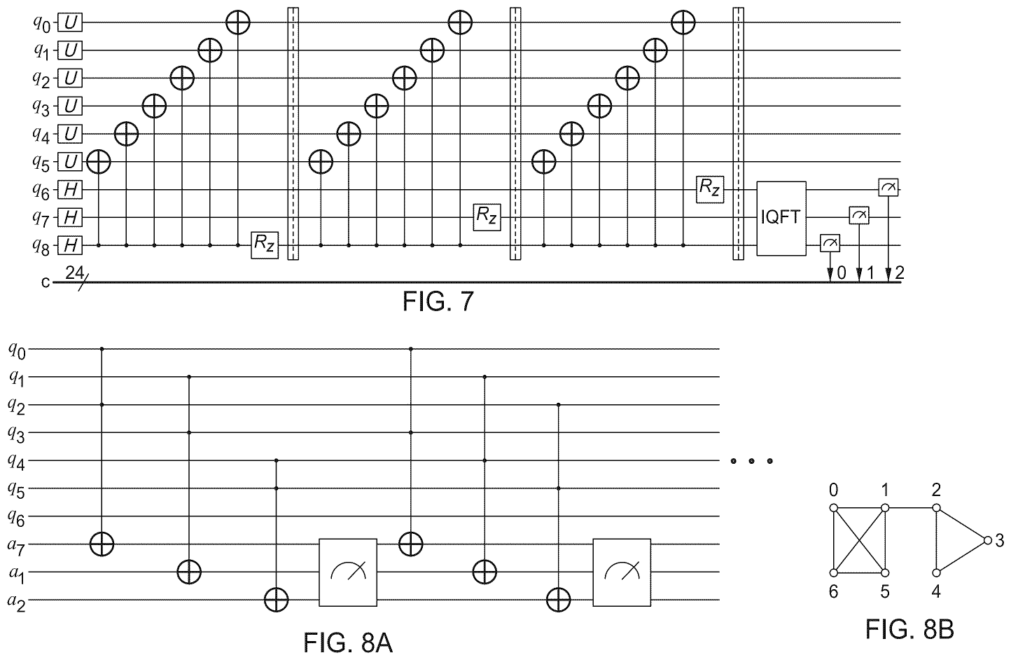

In the QPE, controlled powers of e^{2πiH/2}^{^{m}} are applied controlled on k ancilla qubits (e.g., q₆, q₇, q₈ for k=3) which store the eigenvalues of the QPE operator (which is the Hamming weight k). Each application of e^{2πiH/2}^{^{m}} uses 2N controlled-NOT (CNOT) gates, and then ┌log₂(k+1)┐ (e.g., q₆, q₇, q₈ for k=3) of the QPE operators are applied. Finally, an inverse QFT is applied on the ┌log (k+1)┐ ancilla qubits to transform to the Hamming basis. FIG. 7 shows a circuit to create a Hamming weight k state (k=3) on N=6 vertex qubits.

Step 2: Project the Hamming weight k state onto k-simplices of a specific graph G, and project out all basis states which are not k-cliques of the specific graph G by a projection operator Pₖ.

For example, an edge [0, 1] is in the graph G, a controlled-controlled-NOT (CCNOT) gate, controlled on the vertex qubits (q₀ and q₁), with a target |0 [symbol] ancilla qubit, for each basis state:

$${CCX}_{01} ( \vert 110000 〉 + \vert 101000 〉 ) ⊗ \vert 0 〉 = \vert 110000 〉 \vert 1 〉 + \vert 101000 〉 \vert 0 〉$$

turns the target ancilla qubit to |1 [symbol] if the edge [0, 1] is in the graph G. Since a k-clique is a set of vertices with no missing edges, the projection operator Pₖ is CCNOT gates on all edges not in the graph G (with k target ancilla qubits), and measurement of all zeros on the target ancilla qubits. FIG. 8A shows a circuit of a projection operator Pₖ. (k=3) on N=7 vertex qubits for a graph G shown in FIG. 8B.

Step 3: Apply an unconstrained boundary operator Δₖ to the quantum processor, to analyze topological properties of the graph G. The boundary operator Δₖ (also referred to as “combinatorial Laplacian”) relates to how k-simplexes are connected to each other, and acts as a derivative moving between different “k-simplex” subspaces. When acting on the quantum Hilbert space, the boundary operator Δₖ is a fermionic Hamiltonian. This Laplacian is a quantum operator that can be efficiently implemented on a quantum computer.

The boundary operator removes

$$( {\partial }_{k}^{G} )$$

or adds

$$( {\partial }_{k}^{{G}^{†}} )$$

an edge to a given k-clique with an appropriate sign depending on directionality and gives zero if the resulting k−1/k+1 simplex is not in the graph G. A “k-dimensional hole” is a k-dimensional cycle that is not a boundary of a (k+1)-dimensional object. That is, a closed set of k-dimensional surface that is not itself a k+1 simplex.

The combinatorial Laplacian Δₖ takes the form of a free-fermion Hamiltonian B:

$${Δ}_{k} = {P}_{k} {P}_{Γ} B {P}_{Γ} B {P}_{Γ} B {P}_{Γ} {P}_{k} ,$$

$$B = {\sum }_{i = 1}^{N} ( {a}_{i} + {a}_{i}^{†} ) ⇔ X ⊗ I ⊗ I ⊗ … ⊗ I + Z ⊗ X ⊗ I ⊗ … ⊗ I + … + Z ⊗ Z ⊗ Z ⊗ … ⊗ X ,$$

where Pₖ is a projection to the Hamming weight k states, and P_{Γ} is a projection onto k-simplexes in graph G.

The topological properties of the graph G can be calculated using the boundary operator Δₖ,

$$T r [ {Δ}_{k} ] \approx {\sum }_{ℓ = 0}^{M} 〈 {v}_{ℓ} \vert {Δ}_{k} \vert {v}_{l} 〉 \qquad ( 3 )$$

$$= {\sum }_{ℓ} 〈 {v}_{l} \vert {P}_{k} {P}_{Γ} B {P}_{Γ} B {P}_{Γ} {P}_{k} \vert {v}_{ℓ} 〉 \qquad ( 4 )$$

To estimate (3), the state

$${\vert Ψ 〉}_{ℓ} = {P}_{Γ} B {P}_{Γ} {P}_{k} \vert {v}_{ℓ} 〉 \qquad ( 5 )$$

is created, where | [symbol] is a random Hadamard vector (a sum over all basis states |x [symbol] with random signs on each state |x [symbol] ). Then, the norm |∥105 [symbol] ∥ is calculated through repeated measurements of all qubits.

The free-fermion Hamiltonian B is not unitary, but

$${e}^{iBt} \approx ( 1 - \frac{{t}^{2}}{2} ) I + itB$$

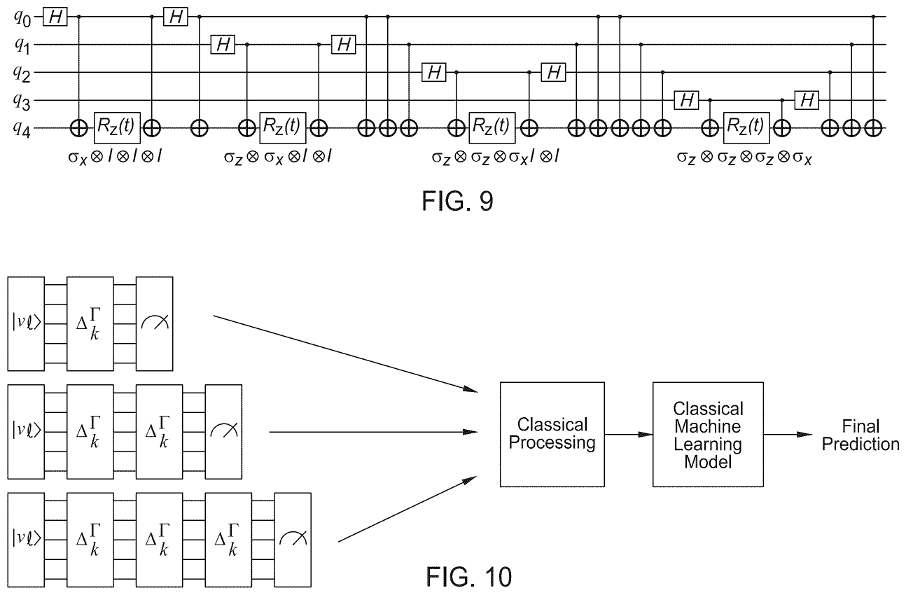

is unitary, and can be implemented on the quantum processor using single qubit rotations and CNOT gates, as shown in FIG. 9. As shown, the number of vertex qubits N=4.

By applying e^{iBt}, a portion of the wavefunction:

$${e}^{iBt} \vert k 〉 \approx ( 1 - \frac{{t}^{2}}{2} ) \vert k 〉 + it \vert Bk 〉$$

can be measured. Since |k [symbol] and |Bk [symbol] are orthogonal, measurement of the state e^{iBt}|k [symbol] provides

$${{{‖ ψ 〉 ‖}^{2} \approx ( 1 - {t}^{2} ) ‖ k 〉 ‖}^{2} + {t}^{2} ‖ Bk 〉 ‖}^{2}$$

with different hamming weights ((1−t²) and t²) in Z basis.

Subsequently, block 604 and block 606 are repeated for different cutoff distances ϵ. The number of zero eigenvalues (the kernel) of the combinatorial Laplacian provides the kth Betti number (the number of k-dimensional holes in the graph G) divided by the total number of k-simplices in the graph G. Thus, calculating properties of the energy spectrum of the combinatorial Laplacian Δₖ provides the Betti number.

In block 608, feature vectors are created from the topological properties of the simplicial complex Γ estimated by the quantum processor, by the classical computer. The feature vectors may be each an estimate of the k-th Betti number for a specific cutoff distance ϵ.

In block 610, properties of the dataset {X} are calculated using the feature vectors, by the classical computer. The properties of the dataset {X} may be Betti curves that can be calculated from the feature vectors and then be directly used to predict the age of the brain sample or to diagnose the presence of Alzheimer's disease.

Several potential features to the quantum TDA portion of the NISQ TDA method are described.

The first feature is the adaptation of the NISQ TDA method to a shorter depth heuristic TDA circuit, where only approximate the first m bits of the Betti number estimation is to be performed, where m is a small number (in the simplest case the first significant digit of the Betti number is to be extracted). In order to perform this approximation, a trapped-ion based quantum processor (QPU), such as the ion chain 106 having trapped ions in the ion trap quantum computing system 100, is used to estimate the trace of the first few powers of the combinatorial Laplacian generated for a specific order k and a specific simplicial complex Γ based on the input data.

The second feature is the potential to merge all the measurement data taken from the QPU with a classical machine learning algorithm which is trained to either estimate the Betti number or to directly predict the final behavior of the data sample based on these measurements. In particular, when applying the QPU component of the algorithm, a quantum circuit which implements powers of the combinatorial Laplacian operator is applied. Typically, the Betti number is calculated by performing a sum of the average expectations values of this set of operators over random vectors. Instead, in the embodiments described herein, all the information from every individual expectation value and post-processing the results is stored, either manually or training a classical machine learning model. These results can then be fed into a separate machine learning model which is trained to produce a final prediction. This workflow is shown in the diagram in FIG. 10, where the quantum circuits on the left demonstrate the process of preparing different initial states, applying multiple powers of the combinatorial Laplacian Δₖ for a specific k and simplicial complex Γ, and the last block of the circuit is the measurement operation.

The third feature is the development of quantum circuit structures for the QPU component of the algorithm which are designed and compiled specifically to run on trapped ion quantum computers, such as the ion trap quantum computing system 100. This includes the development of circuit structures which take advantage of Molmer-Sorenson native gate implementation, as well as compilations which take advantage of the all-to-all connectivity of long single chains of the trapped Ion system. In addition to this, trapped-ion specific error mitigation techniques may be implemented to deal with the noise present in near term quantum devices.

Finally, alternative algorithmic approaches and alternative observables based on applications of the combinatorial Laplacian for analyzing topological structures are developed, which may allow better exploration of regimes of the data which are inaccessible by the previous approaches. These approaches include directly analyzing the low-energy spectrum of the combinatorial Laplacian, using either imaginary time-evolution approaches or variational quantum eigen-solver approaches, in order to calculate the topological properties of the simplicial complex in the regime where the Betti number is small. Projecting the combinatorial Laplacian onto the low-energy subspace may also be explored to enhance resolution in this small Betti number regime.

While the foregoing is directed to specific embodiments, other and further embodiments may be devised without departing from the basic scope thereof, and the scope thereof is determined by the claims that follow.

1. A method of a noisy intermediate-scale quantum device (NISQ) topological data analysis in a hybrid quantum-classical computing system comprising a classical computer and a quantum processor, comprising:
gathering, by the classical computer, dataset;
creating, by the classical computer, a simplicial complex of an order k from the dataset, based on a cutoff distance,
estimating, by the quantum processor, topological properties of the simplicial complex, the estimating comprising:
creating a Hamming weight k state on the quantum processor;
projecting the Hamming weight k state onto k-simplices of a graph G; and
applying a boundary operator to the quantum processor;
creating, by the classical computer, feature vectors from the topological properties of the simplicial complex estimated by the quantum processor; and
calculating, by the classical computer, properties of the dataset.

2. The method of claim 1, wherein the creating of the simplicial complex is repeated based on different cutoff distances.

3. The method of claim 1, further comprising:
merging, on the classical computer, all measurement data collected from the quantum processor using a classical machine learning algorithm.

4. The method of claim 1, wherein the dataset is extracted from a functional MRI (fMRI) scan data of a brain.

5. The method of claim 1, wherein the creating of the simplicial complex comprises the use of the GUDHI library.

6. The method of claim 1, wherein the creating of the Hamming weight k comprises applying single qubit rotations and controlled-NOT gates to the quantum processor.

7. The method of claim 1, wherein the projecting of the Hamming weight k state comprises controlled-controlled-NOT gates to the quantum processor.

8. The method of claim 1, wherein the applying of the boundary operator comprises single qubit rotations and controlled-NOT gates to the quantum processor.

9. A hybrid quantum-classical computing system, comprising:
a classical computer configured to:
gather dataset; and
create a simplicial complex of an order k from the dataset, based on a cutoff distance; and
a quantum processor comprising a plurality of trapped ions, each of the trapped ions having two hyperfine states defining a qubit, wherein the quantum processor configured to:
estimate topological properties of the simplicial complex by:
creating a Hamming weight k state;
projecting the Hamming weight k state onto k-simplices of a graph G; and
applying a boundary operator,
wherein the classical computer is further configured to:
create feature vectors from the topological properties of the simplicial complex estimated by the quantum processor; and
calculate properties of the dataset.

10. The hybrid quantum-classical computing system of claim 9, wherein
each of the trapped ions is ¹⁷¹Yb⁺ having ²S_{1/2} hyperfine states.

11. The hybrid quantum-classical computing system of claim 9, wherein
each of the trapped ions is one selected from Be⁺, Ca⁺, Sr⁺, Mg+, Ba⁺, Zn⁺, Hg⁺, Cd⁺.

12. The hybrid quantum-classical computing system of claim 9, wherein the creating of the simplicial complex is repeated based on different cutoff distances.

13. The hybrid quantum-classical computing system of claim 9, wherein the classical computer is further configured to:
merge all measurement data collected from the quantum processor using a classical machine learning algorithm.

14. The hybrid quantum-classical computing system of claim 9, wherein the dataset is extracted from a functional MRI (fMRI) scan data of a brain.

15. The hybrid quantum-classical computing system of claim 9, wherein the creating of the simplicial complex comprises the use of the GUDHI library.

16. The hybrid quantum-classical computing system of claim 9, wherein the creating of the Hamming weight k comprises applying single qubit rotations and controlled-NOT gates to the quantum processor.

17. The hybrid quantum-classical computing system of claim 9, wherein the projecting of the Hamming weight k state comprises controlled-controlled-NOT gates to the quantum processor.

18. The hybrid quantum-classical computing system of claim 9, wherein the applying of the boundary operator comprises single qubit rotations and controlled-NOT gates to the quantum processor.

19. A quantum computing system for performing a noisy intermediate-scale quantum device (NISQ) topological data analysis, the quantum computing system comprising non-volatile memory having a number of instructions stored therein which, when executed by one or more processors, causes the quantum computing system to perform operations comprising:
gathering, by a classical computer, dataset;
creating, by the classical computer, a simplicial complex of an order k from the dataset, based on a cutoff distance,
estimating, by a quantum processor, topological properties of the simplicial complex, the estimating comprising:
creating a Hamming weight k state on the quantum processor;
projecting the Hamming weight k state onto k-simplices of a graph G; and
applying a boundary operator to the quantum processor;
creating, by the classical computer, feature vectors from the topological properties of the simplicial complex estimated by the quantum processor; and
calculating, by the classical computer, properties of the dataset.

20. The quantum computing system of claim 19, wherein:
the creating of the Hamming weight k comprises applying single qubit rotations and controlled-NOT gates to the quantum processor,
the projecting of the Hamming weight k state comprises controlled-controlled-NOT gates to the quantum processor, and
the applying of the boundary operator comprises single qubit rotations and controlled-NOT gates to the quantum processor.
